(19) United States
(12) Patent Application Publication
(10) Pub. No.: US 2025/0256369 A1
(43) Pub. Date: Aug. 14, 2025

(54) MAGNETIC CHUCK

(71) Applicant: SMC CORPORATION, Tokyo (JP)

(72) Inventors: Craig GODBEY, Noblesville, IN (US); Ryosuke OKUSHIMA, Tsukubamirai-shi (JP)

(73) Assignee: SMC CORPORATION, Tokyo (JP)

(21) Appl. No.: 19/020,166

(22) Filed: Jan. 14, 2025

Related U.S. Application Data
(60) Provisional application No. 63/552,334, filed on Feb. 12, 2024.

(51) Int. Cl. B23Q 3/154; H01F 7/02

(52) U.S. Cl. CPC B23Q 3/1546; H01F 7/0226

(57) ABSTRACT

A cylinder member includes a piston assembly and a cylinder tube, and the piston assembly includes a permanent magnet. A holding force adjustment member includes an adjustment body fixed to the cylinder tube and an adjustment ring having a workpiece holding surface. The adjustment ring is screw-engaged with the adjustment body.

### CROSS-REFERENCE TO RELATED APPLICATIONS

This application is based upon and claims the benefit of priority from U.S. Provisional Application No. 63/552,334 filed on Feb. 12, 2024, the contents of which are incorporated herein by reference.

### BACKGROUND OF THE INVENTION

### Field of the Invention

The present invention relates to a magnetic chuck that is capable of changing the holding force of a workpiece.

### Description of the Related Art

Conventionally, a magnetic chuck has been known in which the magnitude of magnetic attraction force for holding a workpiece can be changed. For example, JP 2019-186324 A discloses a magnetic chuck in which a rod is connected to a piston assembly including a permanent magnet, and an adjuster capable of adjusting the position of the movement end of the piston assembly is attached to the end of the rod that is exposed to the outside.

### SUMMARY OF THE INVENTION

In the magnetic chuck described above, a bottom cover faces the workpiece, and the rod connected to the piston assembly extends upward from a top cover. Therefore, the magnetic chuck cannot be attached to a robot arm above the top cover. That is, a direction in which the magnetic chuck is attached to the robot arm is restricted.

The present invention has the object of solving the aforementioned problem.

The present invention is a magnetic chuck including a base member, a cylinder member, and a holding force adjustment member, wherein the cylinder member includes a piston assembly and a cylinder tube, the piston assembly includes a permanent magnet, the holding force adjustment member includes an adjustment body fixed to the cylinder tube and an adjustment ring provided with a workpiece holding surface. The adjustment ring is screw-engaged with the adjustment body, and the magnetic chuck is configured to change a workpiece holding force by changing a screw-engagement position of the adjustment ring with respect to the adjustment body.

In the magnetic chuck according to the present invention, when the magnetic chuck is attached to a robot arm, there is no restriction on the direction of attachment. In addition, the workpiece holding force can be changed in a stepless manner.

The above and other objects, features, and advantages of the present invention will be easily understood from the following description when taken in conjunction with the accompanying drawings.

### BRIEF DESCRIPTION OF THE DRAWINGS

FIG. 1 is a cross-sectional view of a magnetic chuck according to a first embodiment of the present invention;

FIG. 2 is a view in which the main portion of the magnetic chuck shown in FIG. 1 is expanded into parts;

FIG. 3 is a cross-sectional view of the magnetic chuck shown in FIG. 1 when a piston assembly is in a lower end position;

FIG. 4 is a cross-sectional view of the magnetic chuck shown in FIG. 1 when a position of an adjustment ring is changed downward;

FIG. 5 is a cross-sectional view of a magnetic chuck according to a second embodiment of the present invention;

FIG. 6 is a cross-sectional view of the magnetic chuck shown in FIG. 5 when a position of an adjustment ring is changed upward;

FIG. 7 is a side view of the magnetic chuck of FIG. 5;

FIG. 8 is a view in which the magnetic chuck shown in FIG. 5 is expanded into parts or groups of parts;

FIG. 9 is a cross-sectional view of the magnetic chuck shown in FIG. 5, taken along a plane different from that of FIG. 5;

FIG. 10 is a cross-sectional view of a magnetic chuck according to a third embodiment of the present invention;

FIG. 11 is a cross-sectional view of the magnetic chuck shown in FIG. 10 when a position of an adjustment ring is changed downward;

FIG. 12 is a perspective view of the magnetic chuck shown in FIG. 10 in a state where a part of a cover body is seen through;

FIG. 13 is a view in which the magnetic chuck shown in FIG. 10 is expanded into parts or groups of parts; and

FIG. 14 is a cross-sectional view of the magnetic chuck shown in FIG. 10, taken along a plane different from that of FIG. 10.

### DETAILED DESCRIPTION OF THE INVENTION

### First Embodiment

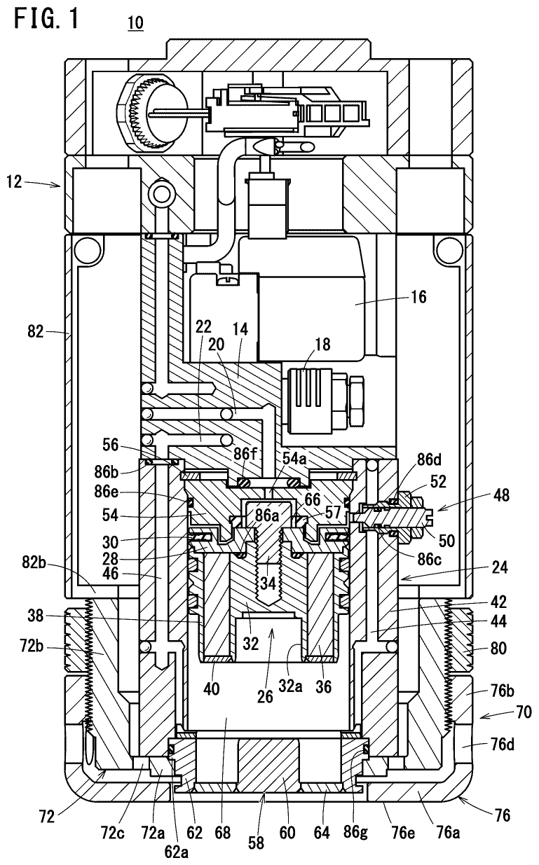

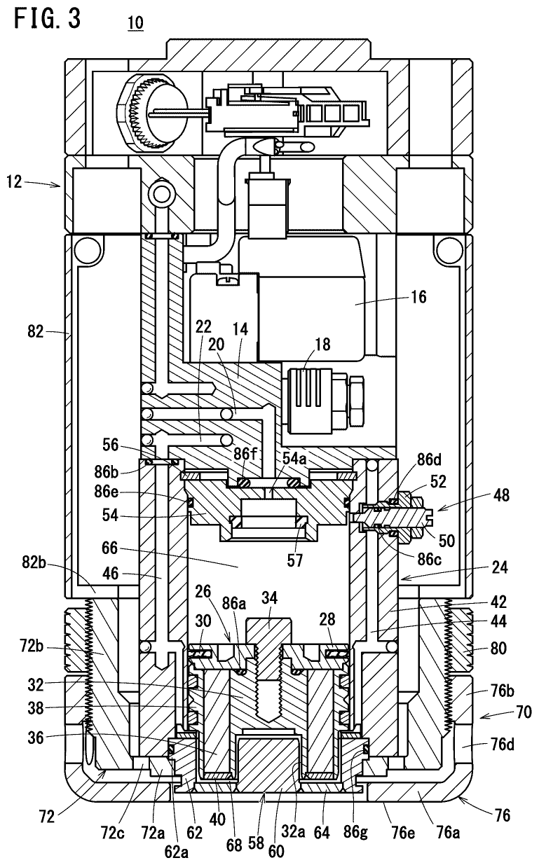

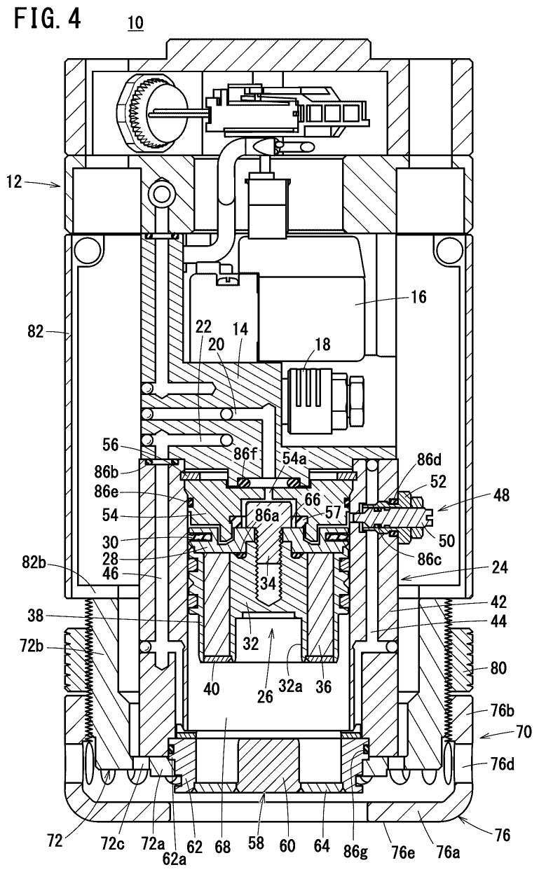

A description will be given with reference to FIGS. 1 to 4 concerning a magnetic chuck 10 according to a first embodiment of the present invention. In the following description, when terms in relation to up and down directions are used, for the sake of convenience, such terms refer to the directions shown in FIG. 1, FIG. 3, and FIG. 4. However, the actual arrangement of the constituent members and the like is not necessarily limited to this feature. As shown in FIG. 1, the magnetic chuck 10 includes a base member 12, a cylinder member 24 disposed below the base member 12, and a holding force adjustment member 70 attached to the cylinder member 24. The magnetic chuck 10, is attached to a non-illustrated robot arm, on an upper end of the base member 12.

The base member 12 includes a block-shaped base body 14. A solenoid valve 16 and an air discharge port 18 are disposed in the base body 14. The base body 14 has a first air supply and discharge hole 20 and a second air supply and discharge hole 22 therein. One end of the first air supply and discharge hole 20 is opened at the center of the lower end portion of the base body 14, and another end of the first air supply and discharge hole 20 is connected to the solenoid valve 16. One end of the second air supply and discharge hole 22 is opened at the center of the lower end portion of the base body 14, and another end of the second air supply and discharge hole 22 is connected to the solenoid valve 16.

The cylinder member 24 includes a piston assembly 26, a cylinder tube 42, a bottom cover 58 and a top cover 54. The cylinder tube 42 is made of a paramagnetic material such as an aluminum alloy and formed in a tubular shape. The upper end opening of the cylinder tube 42 is closed by the top cover 54, and the lower end opening of the cylinder tube 42 is closed by the bottom cover 58. An upper end of the cylinder tube 42 is in contact with a lower end of the base body 14.

The piston assembly 26 includes a seal holder 28, a core yoke 32, a permanent magnet 36, a cover yoke 38, and a ring plate 40. The seal holder 28 is made of a paramagnetic material such as an aluminum alloy and formed in a disk shape. A piston seal 30 mounted on an outer circumference of the seal holder 28 is in sliding contact with an inner wall of the cylinder tube 42. The core yoke 32 is made of a ferrous material that is a ferromagnetic material, and formed in a cylindrical columnar shape. A lower portion of the core yoke 32 includes a recess 32a that has a circular shape in cross section and opens downward. The seal holder 28 is connected to the core yoke 32 by inserting a fixing screw 34 through the center of the seal holder 28 and by the fixing screw 34 being screw-engaged with the upper end portion of the core yoke 32. A first seal member 86a for sealing a gap between the seal holder 28 and the core yoke 32 is mounted on the core yoke 32.

The permanent magnet 36 is fitted on an outer circumference of the core yoke 32. The permanent magnet 36 is formed in a tubular shape and magnetized in a radial direction. In the present embodiment, the permanent magnet 36 has the north pole on its inner circumferential side, and the south pole on its outer circumferential side. On the contrary, the inner circumferential side may be the south pole and the outer circumferential side may be the north pole. The permanent magnet 36 is formed by combining a plurality of fan-shaped magnet pieces divided in the circumferential direction, or is formed of a single constituent element. The cover yoke 38 is fitted on an outer circumference of the permanent magnet 36. The cover yoke 38 is made of a ferrous material that is a ferromagnetic material, and formed in a tubular shape. The ring plate 40 is made of a paramagnetic material such as an aluminum alloy and formed in an annular shape. The permanent magnet 36 is surrounded by the seal holder 28, the core yoke 32, the cover yoke 38, and the ring plate 40.

An internal space of the cylinder tube 42 is partitioned by the piston assembly 26 into a first pressure chamber 66 adjacent to the top cover 54 and a second pressure chamber 68 adjacent to the bottom cover 58. The cylinder tube 42 has a first air passage 44 for placing the second pressure chamber 68 and the first pressure chamber 66 in communication with each other and a second air passage 46 for placing the second pressure chamber 68 and the second air supply and discharge hole 22 of the base body 14 in communication with each other. A second seal member 86b is mounted at a connection portion between the second air passage 46 and the second air supply and discharge hole 22 to seal a gap between the cylinder tube 42 and the base body 14.

A flow rate regulating valve 48 for regulating the flow rate of the air flowing through the first air passage 44 is disposed in the middle of the first air passage 44. When air flows through the first air passage 44, a difference is generated in the pressure of the air between the upstream side and the downstream side of the flow rate regulating valve 48. The flow rate regulating valve 48 is configured as a variable throttle valve and includes a needle valve plug 50 and a support body 52 for supporting the needle valve plug 50. The support body 52 is attached to the cylinder tube 42.

A tip end of the needle valve plug 50 enters the first air passage 44, and a flow passage area of the first air passage 44 changes according to the amount of entry of the needle valve plug 50. The needle valve plug 50 is screw-engaged with the support body 52. By rotating the needle valve plug 50 using a tool, the amount of entry of the needle valve plug 50 can be regulated. A third seal member 86c in contact with the support body 52 is mounted on the needle valve plug 50, and a fourth seal member 86d in contact with the cylinder tube 42 is mounted on the support body 52.

When air is supplied to the first pressure chamber 66 and air is discharged from the second pressure chamber 68, the piston assembly 26 is biased downward by the pressure difference between the air pressure in the first pressure chamber 66 and the air pressure in the second pressure chamber 68. The downward biasing force of the air is changed by rotating the needle valve plug 50 of the flow rate regulating valve 48.

The bottom cover 58 includes a bottom yoke 60, an outer yoke 62, and a connecting plate 64. The bottom yoke 60 is made of a ferrous material that is a ferromagnetic material, and formed in a cylindrical columnar shape. The bottom yoke 60 enters the recess 32a of the core yoke 32 when the piston assembly 26 descends. The outer yoke 62 is disposed in the exterior of the bottom yoke 60. The outer yoke 62 is made of a ferrous material that is a ferromagnetic material, and formed in a cylindrical shape. The annular connecting plate 64 is attached between the lower end of the bottom yoke 60 and the lower end of the outer yoke 62. Accordingly, the outer yoke 62 is fixed to the bottom yoke 60. The connecting plate 64 is made of a paramagnetic material such as an aluminum alloy.

The top cover 54 is made of a ferrous material that is a ferromagnetic material, and formed in a disk shape. The top cover 54 is fixed to an upper portion of the cylinder tube 42 via a C-ring 56. A fifth seal member 86e is mounted on the top cover 54 so as to be in contact with the inner wall of the cylinder tube 42. The top cover 54 has a hole portion 54a penetrating the center of the top cover 54. The first pressure chamber 66 communicates with the first air supply and discharge hole 20 of the base body 14 through the hole portion 54a of the top cover 54. A sixth seal member 86f is disposed between the top cover 54 and the base member 12.

The piston assembly 26 is displaceable upward or downward between an upper end position abutting a damper 57 mounted on the top cover 54 and a lower end position abutting the bottom cover 58. When the piston assembly 26 is in the upper end position, the magnetic flux of the permanent magnet 36 passes through the top cover 54, and thus the piston assembly 26 is attracted toward the top cover 54 (see FIG. 1). That is, a magnetic force acts to hold the piston assembly 26 in the upper end position. When the piston assembly 26 is in the lower end position, the magnetic flux of the permanent magnet 36 passes through the bottom yoke 60 and the outer yoke 62, and thus the piston assembly 26 is attracted toward the bottom cover 58 (see FIG. 3). That is, a magnetic force acts to hold the piston assembly 26 in the lower end position.

When the piston assembly 26 is in the upper end position, even if a workpiece (not shown) such as a steel plate is present near the bottom cover 58, the magnetic force of the permanent magnet 36 does not reach the workpiece. When the piston assembly 26 is in the lower end position, if a workpiece such as a steel plate is present near the bottom cover 58, the magnetic force of the permanent magnet 36 is applied to the workpiece, and the workpiece is attracted and held by the magnetic force of the permanent magnet 36. In this case, most of the magnetic flux that has emitted from the inner circumferential surface of the permanent magnet 36 passes through the core yoke 32, the bottom yoke 60, the workpiece, the outer yoke 62, and the cover yoke 38 in this order, and returns to the outer circumferential surface of the permanent magnet 36.

The holding force adjustment member 70 includes an adjustment body 72, an adjustment ring 76, and a jam ring 80. The adjustment body 72, the adjustment ring 76 and the jam ring 80 are made of a paramagnetic material such as an aluminum alloy. The adjustment body 72 has an annular plate portion 72a and a cylindrical portion 72b extending upward from the plate portion 72a.

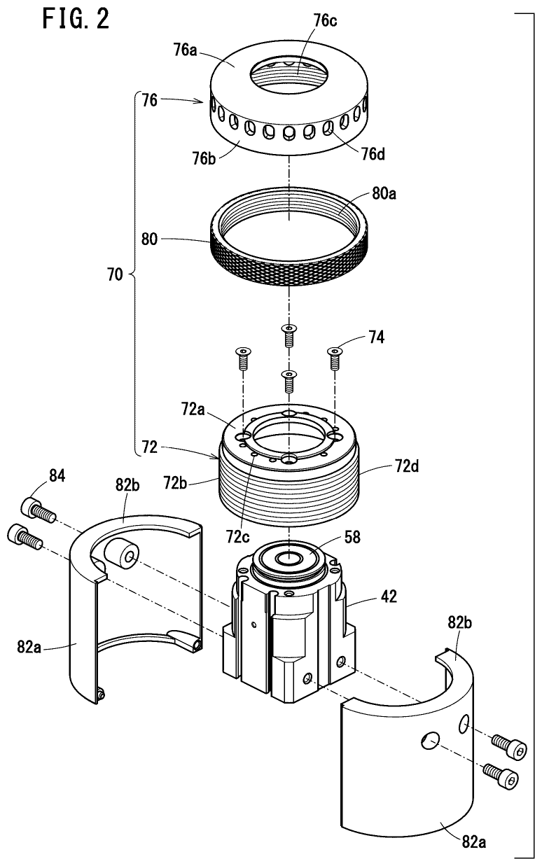

The cylindrical portion 72b of the adjustment body 72 is disposed in the exterior of the cylinder tube 42, and a clearance serving as a passage for cooling air, which will be described later, is formed between the cylindrical portion 72b of the adjustment body 72 and the cylinder tube 42. The cylindrical portion 72b of the adjustment body 72 has an externally threaded portion 72d on the outer circumference thereof. The plate portion 72a of the adjustment body 72 has a plurality of ventilation holes 72c penetrating the plate portion 72a. The adjustment body 72 is fixed to the cylinder tube 42 by inserting a first screw member 74 into the plate portion 72a of the adjustment body 72 and by the first screw member 74 being screw-engaged with the lower end portion of the cylinder tube 42 (see FIG. 2).

The outer yoke 62 of the bottom cover 58 is provided with an annular convex portion 62a projecting from the outer circumferential surface of the outer yoke 62. The convex portion 62a of the outer yoke 62 is sandwiched and held between the plate portion 72a of the adjustment body 72 and the lower end portion of the cylinder tube 42. As a result, the bottom cover 58 is fixed to the cylinder tube 42 together with the adjustment body 72. A seventh seal member 86g is mounted on the convex portion 62a of the outer yoke 62 so as to be in contact with the inner wall of the cylinder tube 42. The outer yoke 62 projects downward below the plate portion 72a of the adjustment body 72.

The adjustment ring 76 has an annular plate portion 76a and a cylindrical portion 76b extending upward from the plate portion 76a. The cylindrical portion 76b of the adjustment ring 76 has an internally threaded portion 76c on the upper inner circumferential surface thereof, and the internally threaded portion 76c is screw-engaged with the externally threaded portion 72d of the adjustment body 72. The cylindrical portion 76b of the adjustment ring 76 has a plurality of ventilation holes 76d penetrating the cylindrical portion 76b. By changing the screw-engagement position of the adjustment ring 76 with respect to the adjustment body 72, the position of the adjustment ring 76 can be changed in the up and down direction.

The cylindrical jam ring 80 is disposed above the adjustment ring 76. The jam ring 80 has an internally threaded portion 80a on the inner circumferential surface thereof, and the internally threaded portion 80a is screwed into the externally threaded portion 72d of the adjustment body 72. The position of the jam ring 80 relative to the adjustment body 72 is changed in accordance with the position of the adjustment ring 76 in the up and down direction. The jam ring 80 serves to hold the adjustment ring 76 in a desired screw-engagement position.

The lower surface of the plate portion 76a of the adjustment ring 76 forms a workpiece holding surface 76e that is in contact with the workpiece and holds the workpiece. The workpiece holding surface 76e is located below the lower ends of the bottom yoke 60 and the outer yoke 62. By changing the position of the adjustment ring 76 in the up and down direction with respect to the adjustment body 72, the force for attracting and holding the workpiece can be changed. As shown in FIG. 1, when the adjustment ring 76 is in the upper end position, the distance from the bottom yoke 60 and the outer yoke 62 to the workpiece holding surface 76e is minimized, and therefore the workpiece holding force is maximized. As shown in FIG. 4, when the adjustment ring 76 is in the lower end position, the distance from the bottom yoke 60 and the outer yoke 62 to the workpiece holding surface 76e is maximized, and therefore the workpiece holding force is minimized.

A cylindrical cover body 82 is disposed in the exterior of the base body 14 and in the upper exterior of the cylinder tube 42. As shown in FIG. 2, the cover body 82 is configured by a pair of semi-cylindrical bodies 82a. The cover body 82 is detachably attached to the cylinder tube 42 by using second screw members 84. That is, the second screw members 84 are inserted into each of the semi-cylindrical bodies 82a, and the distal ends of the second screw members 84 are screw-engaged with the cylinder tube 42.

The lower end of the cover body 82 has an inwardly extending annular flange portion 82b. The tip end of the flange portion 82b of the cover body 82 is aligned with the inner circumferential surface of the adjustment body 72 and faces the outer circumferential surface of the cylinder tube 42 with a predetermined clearance therebetween. As a result, the space formed between the cover body 82 and the upper portion of the cylinder tube 42 is connected to the space formed between the adjustment body 72 and the lower portion of the cylinder tube 42 in a continuous manner.

When the solenoid valve 16 is in a predetermined switching position, air is supplied to the first pressure chamber 66 and air is discharged from the second pressure chamber 68. The air flow in this case is as follows. Air from an air supply source (not shown) is supplied to the first pressure chamber 66 through the solenoid valve 16, after flowing in the first air supply and discharge hole 20 in the base body 14, and the hole portion 54a in the top cover 54. The air supplied to the first pressure chamber 66 flows into the second pressure chamber 68 through the first air passage 44. The air flowing into the second pressure chamber 68 is discharged to the outside via the solenoid valve 16 after flowing through the second air passage 46 and the second air supply and discharge hole 22 of the base body 14.

As described above, when air is supplied to the first pressure chamber 66 and air is discharged from the second pressure chamber 68, the piston assembly 26 is biased downward. The cylinder member 24 is efficiently cooled by the air flowing through the first air passage 44, the second pressure chamber 68 and the second air passage 46. That is, the air supplied for the purpose of biasing the piston assembly 26 downward is also used for cooling the cylinder member 24.

When the solenoid valve 16 is in the switching position described above, the air from the air supply source is discharged as cooling air from the air discharge port 18 via the solenoid valve 16. The cooling air passes through the clearance between the cover body 82 and the base body 14, the clearance between the cover body 82 and the cylinder tube 42, and the clearance between the adjustment body 72 and the cylinder tube 42, and thereafter passes through the ventilation holes 72c of the adjustment body 72. The cooling air having passed through the ventilation holes 72c of the adjustment body 72 passes through the clearance between the plate portion 72a of the adjustment body 72 and the plate portion 76a of the adjustment ring 76, and is then discharged to the outside from the ventilation holes 76d of the adjustment ring 76. The cooling air is circulated through the above mentioned path, whereby the holding force adjustment member 70 including the adjustment ring 76 is efficiently cooled.

In the case that the workpiece attracted and held by the magnetic force of the permanent magnet 36 is at a high temperature, a considerable amount of heat is transmitted from the workpiece to the cylinder member 24 and the adjustment ring 76. The heat transferred from the workpiece to the cylinder member 24, primarily by radiation, is quickly removed by the air, which biases the piston assembly 26 downward, flowing through the first air passage 44, the second pressure chamber 68, and the second air passage 46. The heat transmitted from the workpiece to the adjustment ring 76, primarily by conduction, is rapidly removed by the cooling air flowing through the above-mentioned path. By the above actions, the piston seal 30 and the first to seventh seal members 86a to 86g are protected from heat. The adjustment ring 76 greatly limits the heat transferred from the workpiece to the cylinder member 24.

The cylinder tube 42 has a passage (not shown) for supplying air to the second pressure chamber 68 and a passage (not shown) for discharging air from the first pressure chamber 66, and these passages are connected to the solenoid valve 16. When air is supplied to the second pressure chamber 68 and air is discharged from the first pressure chamber 66, the piston assembly 26 is biased upward. The air supplied to bias the piston assembly 26 upward need not be used to cool the cylinder member 24. This is because in the case that the piston assembly 26 is biased upward, the workpiece is released from the magnetic chuck 10 and heat is not transmitted from the workpiece to the cylinder member 24.

The second air supply and discharge hole 22 and the second air passage 46 may be used as passages for supplying air to the second pressure chamber 68, and the first air supply and discharge hole 20 may be used as a passage for discharging air from the first pressure chamber 66. That is, the flow of air when the piston assembly 26 is biased upward may be opposite to the flow of air when the piston assembly 26 is biased downward.

Next, the operation of the magnetic chuck 10 according to the present embodiment will be described. As shown in FIG. 1, an initial state is a state in which the magnetic flux of the permanent magnet 36 passes through the top cover 54 and the piston assembly 26 is held at the upper end position. In the initial state, the adjustment ring 76 is adjusted to the upper end position with respect to the adjustment body 72.

When a command to attract and hold a workpiece such as an unillustrated iron plate placed on a floor surface or the like is issued, a robot arm to which the magnetic chuck 10 is attached is driven, and the magnetic chuck 10 approaches the workpiece. In parallel with this, the solenoid valve 16 is switched, and air is supplied to the first pressure chamber 66 and air in the second pressure chamber 68 is discharged. The piston assembly 26 is biased downward by the differential pressure between the air pressure in the first pressure chamber 66 and the air pressure in the second pressure chamber 68. The downward biasing force of the air exceeds the force by which the piston assembly 26 is attracted to the top cover 54 by the magnetic force, and the piston assembly 26 is displaced downward. The piston assembly 26 abuts against the bottom cover 58 and reaches the lower end position (see FIG. 3).

When the magnetic chuck 10 further approaches the workpiece and the workpiece holding surface 76e of the adjustment ring 76 faces the workpiece within a predetermined distance, the magnetic force of the permanent magnet 36 is applied to the workpiece. The workpiece abuts against the workpiece holding surface 76e of the adjustment ring 76 and is attracted and held by the magnetic force. Since the adjustment ring 76 is adjusted to the upper end position with respect to the adjustment body 72, the workpiece is held with the maximum workpiece holding force.

The magnetic chuck 10 holding the workpiece is transported to a predetermined position by the driving of the robot arm. Thereafter, the solenoid valve 16 is switched again, and air is supplied to the second pressure chamber 68 and air in the first pressure chamber 66 is discharged. The piston assembly 26 is biased upward by air. The upward biasing force of the air exceeds the force that pulls the piston assembly 26 toward the bottom cover 58 by magnetic force, causing the piston assembly 26 to be displaced upward. The piston assembly 26 abuts against the damper 57 to reach the upper end position.

When the piston assembly 26 reaches the upper end position, the piston assembly 26 is attracted to the top cover 54 by magnetic force. Therefore, even when the supply of air to the second pressure chamber 68 is stopped, the piston assembly 26 is maintained at the upper end position. The position of the adjustment ring 76 in the up and down direction is adjusted in accordance with the thickness, weight, material (magnetic permeability), and the like of the workpiece. When the thickness and weight of the workpiece are sufficiently small, the adjustment ring 76 may be adjusted to be in the vicinity of the lower end position as shown in FIG. 4.

In the magnetic chuck 10 according to the present embodiment, the holding force adjustment member 70 includes the adjustment body 72 fixed to the cylinder tube 42 and the adjustment ring 76 including the workpiece holding surface 76e, and the adjustment ring 76 is screw-engaged with the adjustment body 72. Therefore, when the magnetic chuck 10 is attached to the robot arm, there is no restriction on the direction of attachment. In addition, the workpiece holding force can be changed in a stepless manner.

Further, the cylinder tube 42 includes the first air passage 44 for placing the second pressure chamber 68 and the first pressure chamber 66 in communication with each other and the second air passage 46 for placing the second pressure chamber 68 and the second air supply and discharge hole 22 in communication with each other, the first pressure chamber 66 communicates with the first air supply and discharge hole 20, and the flow rate regulating valve 48 is disposed in the first air passage 44. Thus, the air supplied to bias the piston assembly 26 downward can be used to cool the cylinder member 24.

Furthermore, the cooling air from the air discharge port 18 is discharged to the outside from the ventilation holes 76d of the adjustment ring 76 through at least the clearance between the adjustment body 72 and the adjustment ring 76. Therefore, the heat transferred from the workpiece to the adjustment ring 76 is rapidly removed, and as a result, the heat transferred from the workpiece to the cylinder member 24 is greatly limited.

### Second Embodiment

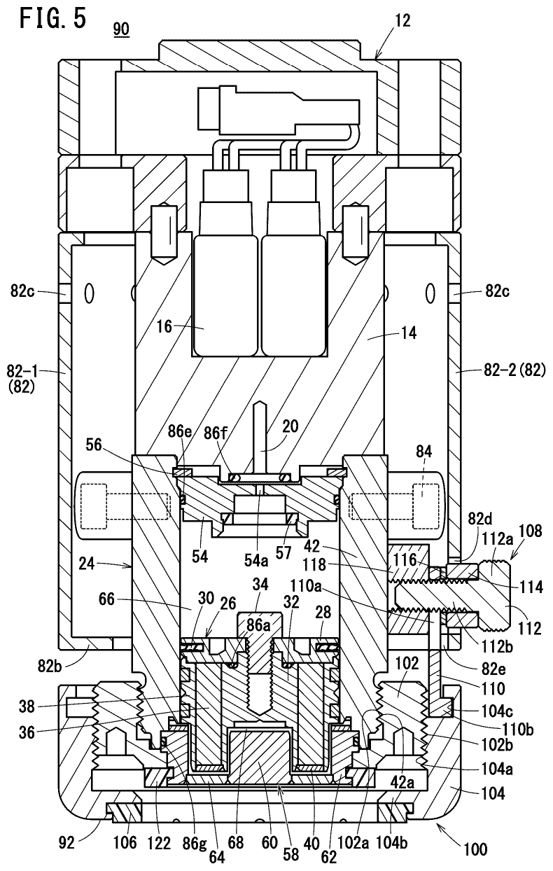

Next, a magnetic chuck 90 according to a second embodiment of the present invention will be described with reference to FIGS. 5 to 9. In the magnetic chuck 90 according to the second embodiment, constituent elements that are the same as or equivalent to those of the above-described magnetic chuck 10 may be denoted by the same reference numerals, and detailed description thereof may be omitted. In the following description, when terms in relation to up and down directions are used, for the sake of convenience, such terms refer to the directions shown in the drawings, however, the actual arrangement of the constituent members and the like is not necessarily limited to this feature.

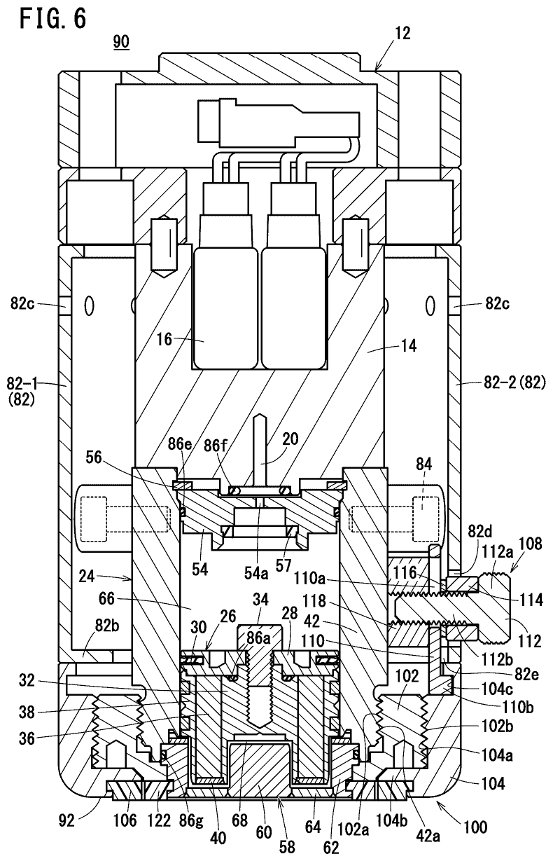

As shown in FIGS. 5 and 6, the magnetic chuck 90 includes a base member 12, a cylinder member 24 disposed below the base member 12, and a holding force adjustment member 100 attached to the cylinder member 24. The magnetic chuck 90 is attached to a non-illustrated robot arm, on an upper end of the base member 12. The holding force adjustment member 100 includes an adjustment body 102, an adjustment ring 104, and a locking mechanism member 108.

The cylindrical adjustment body 102 has an inner circumferential surface provided with an internally threaded portion 102a, and the lower end of the cylinder tube 42 has an outer circumferential surface provided with an externally threaded portion 42a. The adjustment body 102 is fixed to the cylinder tube 42 by the internally threaded portion 102a of the adjustment body 102 being screw-engaged with the externally threaded portion 42a of the cylinder tube 42. The adjustment body 102 is screwed-engaged with the cylinder tube 42 by a reverse thread screw, and when the adjustment body 102 is rotated counterclockwise, the screw-engagement progresses.

The cylindrical adjustment ring 104 has an inner circumferential surface provided with an internally threaded portion 104a, and the adjustment body 102 has an outer circumferential surface provided with an externally threaded portion 102b. The internally threaded portion 104a of the adjustment ring 104 is screw-engaged with the externally threaded portion 102b of the adjustment body 102. The adjustment ring 104 is screw-engaged with the adjustment body 102 by a standard thread screw, and when the adjustment ring 104 is rotated clockwise, the screw-engagement progresses.

The lower end of the adjustment ring 104 has an annular recess by forming a flange portion 104b projecting inward. An annular pad 106 having a predetermined elasticity is mounted in the recess. The lower surface of the adjustment ring 104 and the lower surface of the pad 106 form a workpiece holding surface 92. The upper end of the adjustment ring 104 has an annular groove 104c in its inner circumference. A constituent element denoted by the reference numeral 122 is a pad attached to the lower end of the bottom cover 58.

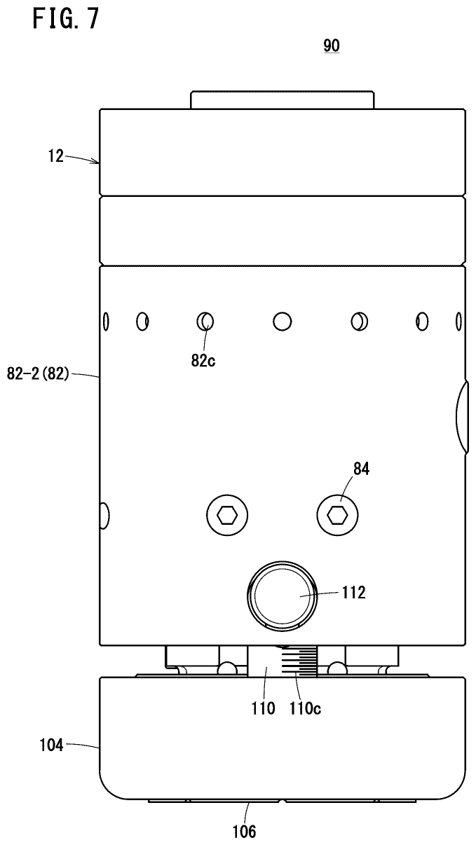

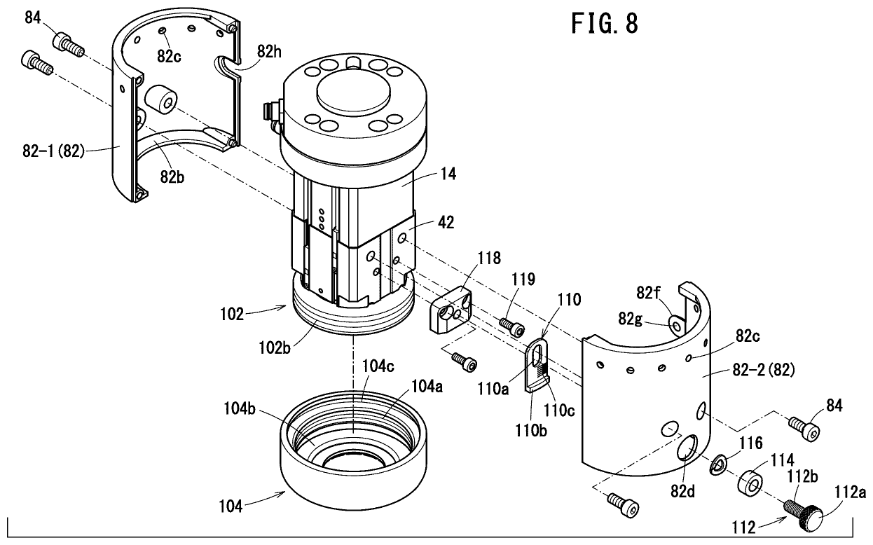

The locking mechanism member 108 includes a locking plate 110, a knob screw 112 and a block 118. As shown in FIG. 8, the locking plate 110 has a slot 110a extending in the up and down direction. The lower end of the locking plate 110 is provided with a convex engaging portion 110b projecting outward. The engaging portion 110b of the locking plate 110 engages with the annular groove 104c of the adjustment ring 104. As a result, the adjustment ring 104 is prevented from moving in the up and down direction (in a direction parallel to the axis of the adjustment ring 104) while being allowed to rotate around the axis of the adjustment ring 104, with respect to the locking plate 110. As shown in FIG. 7, a scale 110c visible from the outside is displayed at the lower portion of the locking plate 110.

The knob screw 112 has a knob portion 112a and a shaft portion 112b formed with an external thread. A spacer 114 and a wave washer 116 are disposed between the knob portion 112a of the knob screw 112 and the locking plate 110. The block 118 is secured to the outer surface of the cylinder tube 42 using fixing screws 119. The shaft portion 112b of the knob screw 112 is inserted through the spacer 114 and the wave washer 116, and further inserted through the slot 110a of the locking plate 110, and then screw-engaged with the block 118.

When the knob screw 112 is screw-engaged with the block 118 by a predetermined amount, the locking plate 110 is sandwiched and held between the wave washer 116 and the block 118, and is fixed to the cylinder tube 42. In the state where the locking plate 110 is fixed to the cylinder tube 42, the adjustment ring 104 engaged with the locking plate 110 is not only fixed in the up and down direction but also prevented from rotating with respect to the adjustment body 102 that is integral with the cylinder tube 42. That is, the adjustment ring 104 is locked in a predetermined screw-engagement position with respect to the adjustment body 102.

The workpiece holding force can be changed by changing the screw-engagement position of the adjustment ring 104 with respect to the adjustment body 102. As shown in FIG. 6, when the upper end of the adjustment ring 104 abuts against a cover body 82 to be described later and the adjustment ring 104 is positioned at the uppermost position, the workpiece holding force is maximized. As shown in FIG. 5, when the shaft portion 112b of the knob screw 112 is positioned at the upper end of the slot 110a of the locking plate 110 and the adjustment ring 104 is positioned at the lowermost position, the workpiece holding force is minimized.

When the adjustment ring 104 locked at the predetermined screw-engagement position is changed to another screw-engagement position, the knob screw 112 is first loosened to release the locking plate 110 from the cylinder tube 42. In accordance with this feature, the screw-engagement position of the adjustment ring 104 can be changed with respect to the adjustment body 102. Next, the adjustment ring 104 is rotated while the scale 110c of the locking plate 110 is visually recognized.

When the adjustment ring 104 is rotated, the shaft portion 112b of the knob screw 112 relatively moves in the slot 110a of the locking plate 110, and the locking plate 110 moves in the up and down direction together with the adjustment ring 104. After the adjustment ring 104 is rotated to the desired position, the knob screw 112 is tightened to fix the locking plate 110 to the cylinder tube 42 again. Accordingly, the adjustment ring 104 is locked relative to the adjustment body 102 in the desired screw-engagement position.

As described above, the adjustment body 102 and the cylinder tube 42 are screw-engaged by the left-hand screw thread, while the adjustment ring 104 and the adjustment body 102 are screw-engaged by the right-hand screw thread. Therefore, when the adjustment ring 104 is rotated, the screw-engagement between the adjustment body 102 and the cylinder tube 42 is prevented from being unexpectedly loosened.

A cylindrical cover body 82 is disposed in the exterior of the base body 14 and in the exterior of the cylinder tube 42. As shown in FIG. 8, the cover body 82 is configured by a pair of semi-cylindrical bodies 82-1 and 82-2. The cover body 82 is detachably attached to the cylinder tube 42 by using second screw members 84. That is, the second screw members 84 are inserted through the respective semi-cylindrical bodies 82-1 and 82-2, and the distal ends of the second screw members 84 are screw-engaged with the cylinder tube 42.

The lower end of each of the semi-cylindrical bodies 82-1 and 82-2 has an inwardly extending annular flange portion 82b. The upper portion of each of the semi-cylindrical bodies 82-1 and 82-2 has a plurality of ventilation holes 82c arranged in the circumferential direction. The one semi-cylindrical body 82-2 has a first hole portion 82d through which the spacer 114 is inserted. The flange portion 82b of the one semi-cylindrical body 82-2 has a second hole portion 82e through which the locking plate 110 is inserted, and the upper portion of the locking plate 110 is positioned inside the cover body 82. A projecting portion 82f formed in the one semi-cylindrical body 82-2 is fitted into a notch portion 82h formed in the other semi-cylindrical body 82-1. The projecting portion 82f is formed with a through hole 82g for insertion of a tool.

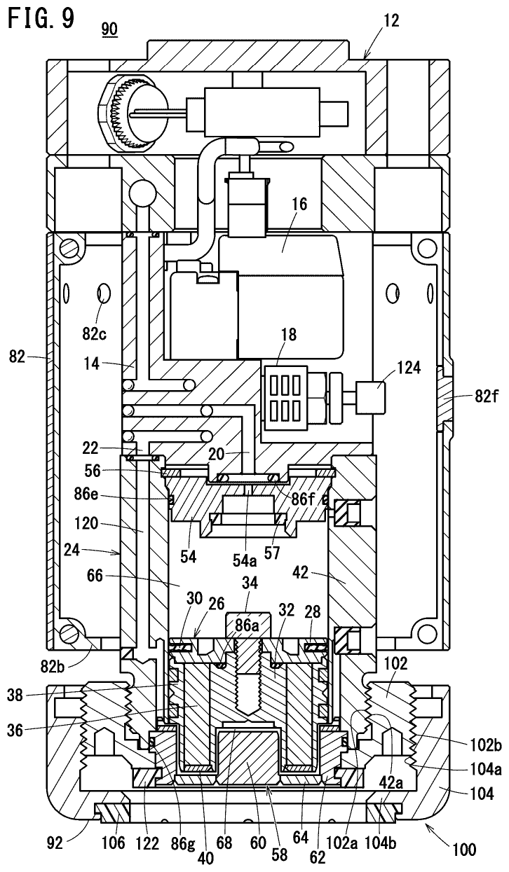

As shown in FIG. 9, a solenoid valve 16 and an air discharge port 18 are disposed in the base body 14. A variable throttle valve 124 capable of adjusting the flow rate of the discharged air is attached to the air discharge port 18. By inserting a tool through the through hole 82g of the cover body 82, the flow passage area of the variable throttle valve 124 can be changed from the exterior of the cover body 82. That is, the flow rate of the air discharged from the air discharge port 18 can be adjusted without removing the cover body 82 from the cylinder tube 42.

The base body 14 has a first air supply and discharge hole 20 and a second air supply and discharge hole 22. One end of the first air supply and discharge hole 20 is opened at the center of the lower end of the base body 14, and another end of the first air supply and discharge hole 20 is connected to the solenoid valve 16. One end of the second air supply and discharge hole 22 is opened at the center of the lower end portion of the base body 14, and another end of the second air supply and discharge hole 22 is connected to the solenoid valve 16.

An internal space of the cylinder tube 42 is partitioned by the piston assembly 26 into a first pressure chamber 66 adjacent to the top cover 54 and a second pressure chamber 68 adjacent to the bottom cover 58. The cylinder tube 42 includes an air passage 120 that places the second pressure chamber 68 and the second air supply and discharge hole 22 of the base body 14 in communication with each other. The top cover 54 has a hole portion 54a penetrating the center of the top cover 54. The first pressure chamber 66 communicates with the first air supply and discharge hole 20 of the base body 14 through the hole portion 54a of the top cover 54.

When the solenoid valve 16 is in the first switching position, air is supplied to the first pressure chamber 66 and air is discharged from the second pressure chamber 68, thereby biasing the piston assembly 26 downward. The air discharged from the second pressure chamber 68 passes through the air passage 120 of the cylinder tube 42 and the second air supply and discharge hole 22 of the base body 14, and is discharged from the air discharge port 18 toward the inside of the cover body 82 via the solenoid valve 16. The air discharged from the air discharge port 18 is discharged to the outside through the ventilation holes 82c of the cover body 82.

When the solenoid valve 16 is in the second switching position, air is supplied to the second pressure chamber 68 and air is discharged from the first pressure chamber 66, so that the piston assembly 26 is biased upward. The air discharged from the first pressure chamber 66 passes through the first air supply and discharge hole 20 of the base body 14, and then is discharged from the air discharge port 18 toward the inside of the cover body 82 via the solenoid valve 16.

In the magnetic chuck 90 according to the present embodiment, the holding force adjustment member 100 includes the adjustment body 102 fixed to the cylinder tube 42 and the adjustment ring 104 including the workpiece holding surface 92, and the adjustment ring 104 is screw-engaged with the adjustment body 102. Therefore, when the magnetic chuck 90 is attached to the robot arm, there is no restriction on the direction of attachment.

The holding force adjustment member 100 includes the locking plate 110 that can be fixed to the cylinder tube 42, and the adjustment ring 104 is prevented from moving relative to the locking plate 110 in a direction parallel to the axis of the adjustment ring 104. The screw-engagement position of the adjustment ring 104 with respect to the adjustment body 102 can be adjusted in a stepless manner, and the adjustment ring 104 can be locked reliably at the adjusted screw-engagement position. That is, it is possible to obtain a reliable workpiece holding force that can be changed in a stepless manner.

### Third Embodiment

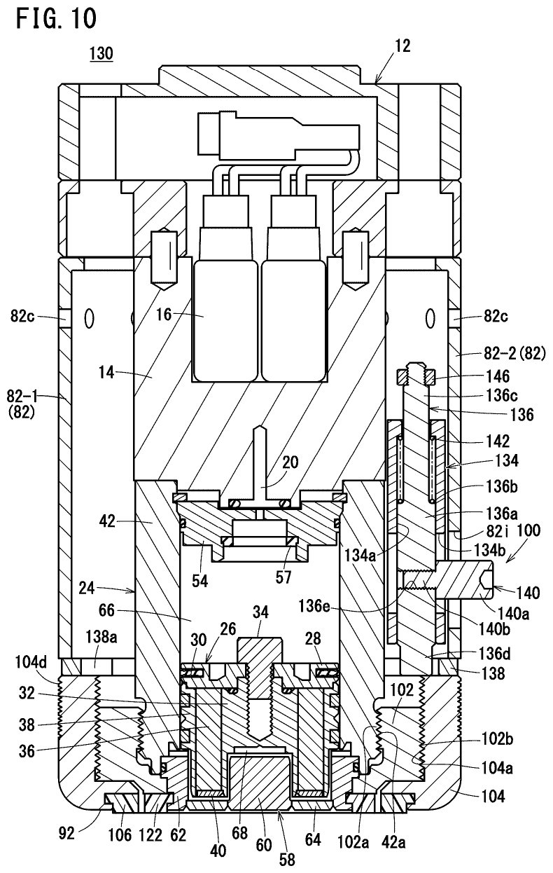

Next, a magnetic chuck 130 according to a third embodiment of the present invention will be described with reference to FIGS. 10 to 14. In the magnetic chuck 130 according to the third embodiment, constituent elements that are the same as or equivalent to those of the above-described magnetic chuck 10 or the above-described magnetic chuck 90 may be denoted by the same reference numerals, and detailed description thereof may be omitted. In the following description, when terms in relation to up and down directions are used, for the sake of convenience, such terms refer to the directions shown in the drawings, however, the actual arrangement of the constituent members and the like is not necessarily limited to this feature.

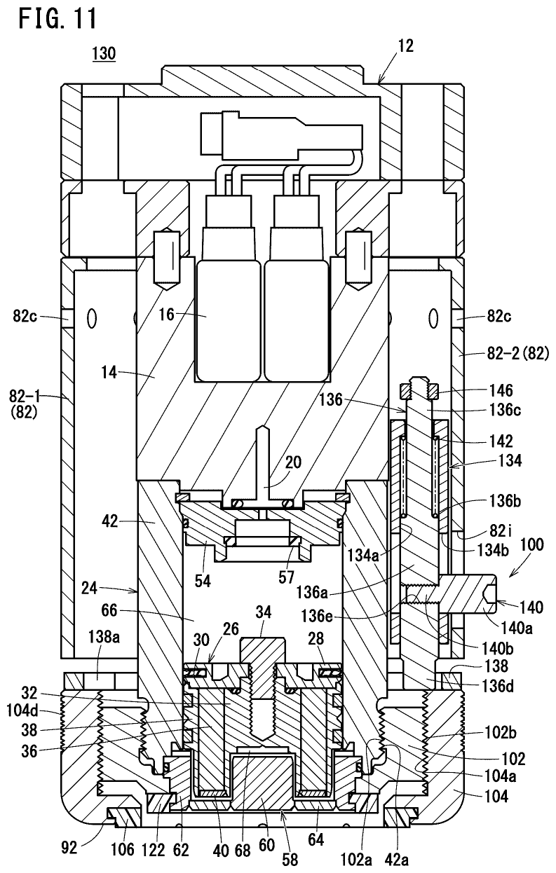

As shown in FIGS. 10 and 11, the magnetic chuck 130 includes a base member 12, a cylinder member 24 disposed below the base member 12, and a holding force adjustment member 100 attached to the cylinder member 24. The magnetic chuck 130 is attached to a non-illustrated robot arm, on an upper end of the base member 12. The holding force adjustment member 100 includes an adjustment body 102, an adjustment ring 104, and a locking mechanism member.

The adjustment body 102 is fixed to the cylinder tube 42 by the internally threaded portion 102a of the adjustment body 102 being screw-engaged with the externally threaded portion 42a of the cylinder tube 42. The internally threaded portion 104a of the adjustment ring 104 is screw-engaged with the externally threaded portion 102b of the adjustment body 102. The lower surface of the adjustment ring 104 and the lower surface of the pad 106 form a workpiece holding surface 92. The side surface of the adjustment ring 104 has a knurled portion 104d to prevent slippage.

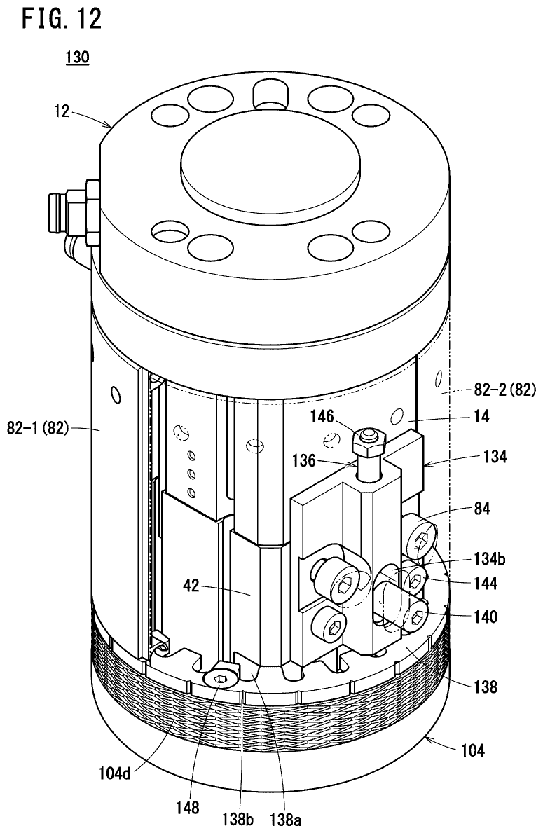

The locking mechanism member includes a support body 134, a locking shaft 136, a locking ring 138, a release knob 140, and a biasing spring 142. As shown in FIG. 12, the support body 134 is disposed over the exterior of the base body 14 and the exterior of the cylinder tube 42, and is fixed to the outer surface of the cylinder tube 42 by using third screw members 144. The support body 134 has a hole portion 134a through which the locking shaft 136 is inserted. The support body 134 has an elongate hole 134b extending in the up and down direction in a wall portion away from the cylinder tube 42.

The locking shaft 136 has a main body portion 136a having a large diameter, a small diameter portion 136c extending upward from the main body portion 136a through a stepped portion 136b, and an engaging portion 136d projecting downward from the main body portion 136a. The main body portion 136a of the locking shaft 136 is inserted into and supported by the hole portion 134a of the support body 134. The locking shaft 136 is displaceable in the axial direction (the up and down direction) of the locking shaft 136, but is not displaceable in the direction intersecting the axis of the locking shaft 136.

The main body portion 136a of the locking shaft 136 has a screw hole 136e penetrating in the radial direction. A part of the small diameter portion 136c of the locking shaft 136 projects upward from the support body 134, and a nut 146 is fixed to a projecting end of the small diameter portion 136c. The nut 146 prevents the locking shaft 136 from slipping out of the support body 134 downward. The engaging portion 136d of the locking shaft 136 has a rectangular cross section and projects downward from the support body 134.

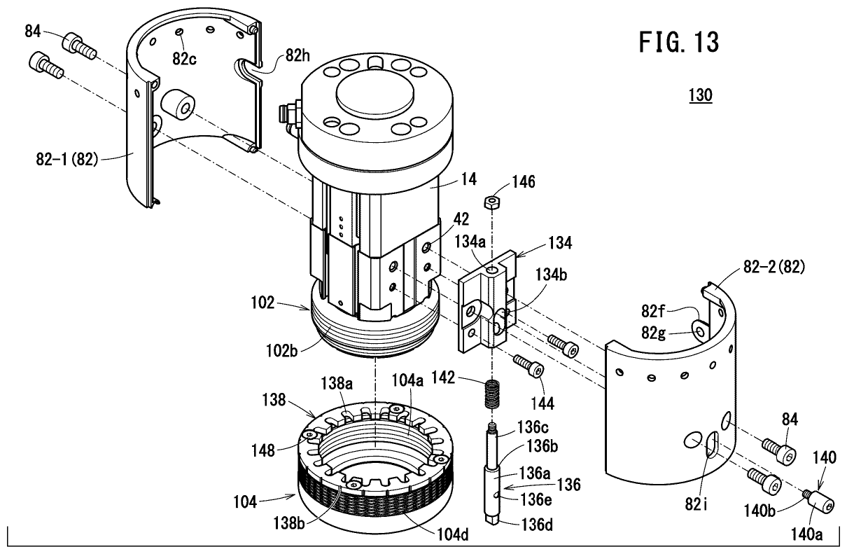

The locking ring 138 is secured to the upper end of the adjustment ring 104 by a fourth screw member 148. As shown in FIG. 13, a plurality of groove portions 138a are formed at equal angular intervals on the inner circumference of the annular locking ring 138. The engaging portion 136d of the locking shaft 136 is fitted into one of the groove portions 138a of the locking ring 138. Accordingly, the rotation of the locking ring 138 and the adjustment ring 104 is restricted. That is, the adjustment ring 104 is locked in a predetermined screw-engagement position with respect to the adjustment body 102. A plurality of notches 138b extending in the up and down direction are formed in an outer circumferential surface of the locking ring 138. Each of the notches 138b is formed at a position corresponding to each of the groove portions 138a in the radial direction.

The release knob 140 has a main body portion 140a having a cylindrical columnar shape and a threaded portion 140b projecting from the main body portion 140a. The threaded portion 140b of the release knob 140 is screw-engaged with the screw hole 136e of the locking shaft 136, whereby the release knob 140 is fixed to the locking shaft 136. The main body portion 140a of the release knob 140 is inserted through the elongate hole 134b of the support body 134 and an elongate hole 82i formed in a cover body 82, and a part of the main body portion 140a projects outward from the cover body 82. The main body portion 140a of the release knob 140 is movable up and down in the elongate hole 134b of the support body 134.

The biasing spring 142, which is a coil spring, is disposed between the stepped portion 136b of the locking shaft 136 and the inner wall of the support body 134. The locking shaft 136 is biased downward by a biasing spring 142, and the lower end of the engaging portion 136d of the locking shaft 136 abuts against the upper end of the adjustment ring 104. As a result, the state in which the engaging portion 136d of the locking shaft 136 is fitted in the groove portions 138a of the locking ring 138 is maintained.

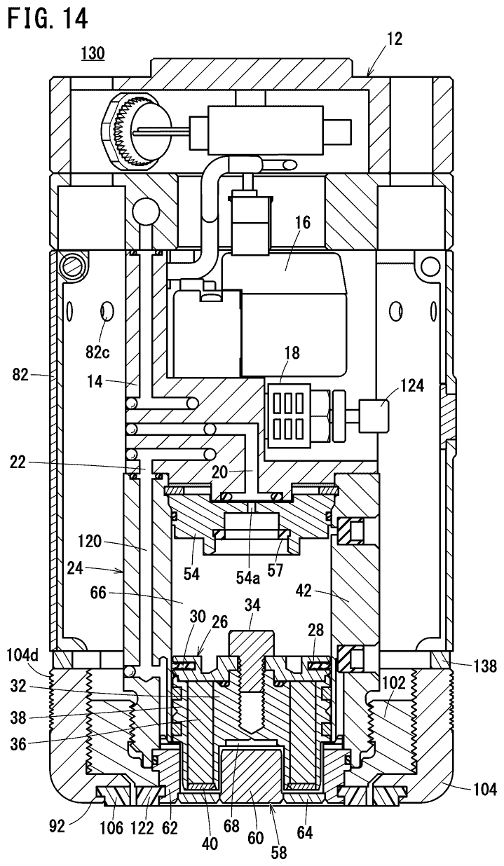

As shown in FIG. 14, the base body 14 has a first air supply and discharge hole 20 and a second air supply and discharge hole 22. One end of the first air supply and discharge hole 20 and the second air supply and discharge hole 22 are opened in the lower end portion of the base body 14, and another end of the first air supply and discharge hole 20 and another end of the second air supply and discharge hole 22 are connected to the solenoid valve 16. An internal space of the cylinder tube 42 is partitioned by the piston assembly 26 into a first pressure chamber 66 adjacent to the top cover 54 and a second pressure chamber 68 adjacent to the bottom cover 58. The cylinder tube 42 includes an air passage 120 that places the second pressure chamber 68 and the second air supply and discharge hole 22 in communication with each other. The first pressure chamber 66 communicates with the first air supply and discharge hole 20 through the hole portion 54a of the top cover 54.

The workpiece holding force can be changed by changing the screw-engagement position of the adjustment ring 104 with respect to the adjustment body 102. As shown in FIG. 10, when the locking ring 138 integral with the adjustment ring 104 abuts against the cover body 82 and the adjustment ring 104 is positioned at the uppermost position, the workpiece holding force is maximized. As shown in FIG. 11, when the main body portion 140a of the release knob 140 abuts against the lower end of the elongate hole 134b of the support body 134 and the adjustment ring 104 is positioned at the lowermost position, the workpiece holding force is minimized.

When the adjustment ring 104 locked at a predetermined screw-engagement position is changed to another screw-engagement position, the release knob 140 projecting outward from the cover body 82 is gripped first, and the release knob 140 and the locking shaft 136 are displaced upward against the biasing force of the biasing spring 142. When the locking shaft 136 is displaced upward, the engaging portion 136d of the locking shaft 136 is disengaged from any of the groove portions 138a of the locking ring 138.

The adjustment ring 104 is rotated to a desired position while the release knob 140 and the locking shaft 136 are displaced upward. At this time, it is possible to visually confirm that a predetermined notch 138b of the locking ring 138 is positioned just below the release knob 140. When the release knob 140 is released from the grip after the adjustment ring 104 is rotated to a desired position, the engaging portion 136d of the locking shaft 136 is fitted into the predetermined groove portion 138a of the locking ring 138 by the action of the biasing spring 142. Accordingly, the adjustment ring 104 is locked relative to the adjustment body 102 in the desired screw-engagement position. That is, the adjustment ring 104 is locked relative to the adjustment body 102 in the desired position in the up and down direction.

The position in the up and down direction at which the adjustment ring 104 is locked is adjusted in small increments in units of a length (P/n) obtained by dividing the pitch (P) of the internally threaded portion 104a of the adjustment ring 104 by the number (n) of the groove portions 138a formed in the locking ring 138. The more the number of the groove portions 138a is, the more finely a locking position of the adjustment ring 104 is adjusted.

In the magnetic chuck 130 according to the present embodiment, the holding force adjustment member 100 includes the adjustment body 102 fixed to the cylinder tube 42 and the adjustment ring 104 including the workpiece holding surface 92, and the adjustment ring 104 is screw-engaged with the adjustment body 102. Therefore, when the magnetic chuck 130 is attached to the robot arm, there is no restriction on the direction of attachment.

Further, the holding force adjustment member 100 includes the locking shaft 136 supported by the support body 134 fixed to the cylinder tube 42 and the annular locking ring 138 fixed to the adjustment ring 104, and the plurality of groove portions 138a into which the engaging portion 136d of the locking shaft 136 is fitted are formed in the inner circumference of the locking ring 138. Therefore, the screw-engagement position of the adjustment ring 104 relative to the adjustment body 102 can be finely adjusted, and also the adjustment ring 104 can be securely locked at the adjusted screw-engagement position. That is, it is possible to easily obtain a reliable workpiece holding force that can be finely changed.

It should be noted that the present invention is not limited to the embodiments described above, and various alternative or additional configurations could be adopted therein without departing from the essence and gist of the present invention as set forth in the appended claims.

1. A magnetic chuck comprising: a base member; a cylinder member; and a holding force adjustment member, wherein the cylinder member includes a piston assembly and a cylinder tube, the piston assembly includes a permanent magnet, the holding force adjustment member includes an adjustment body fixed to the cylinder tube and an adjustment ring provided with a workpiece holding surface, the adjustment ring is screw-engaged with the adjustment body, and the magnetic chuck is configured to change a workpiece holding force by changing a screw-engagement position of the adjustment ring with respect to the adjustment body.

2. The magnetic chuck according to claim 1, wherein the holding force adjustment member includes a jam ring configured to be screw-engaged with the adjustment body.

3. The magnetic chuck according to claim 1, wherein the holding force adjustment member includes a locking plate configured to be fixed to the cylinder tube, and the adjustment ring is prevented from moving in a direction parallel to an axis of the adjustment ring with respect to the locking plate.

4. The magnetic chuck according to claim 3, wherein the holding force adjustment member includes a knob screw screw-engaged with a block fixed to the cylinder tube, a wave washer is disposed between the locking plate and a knob portion of the knob screw, and the locking plate is sandwiched and held between the wave washer and the block when the knob screw is screw-engaged with the block by a predetermined amount.

5. The magnetic chuck according to claim 4, wherein the locking plate has a slot through which a shaft portion of the knob screw is inserted.

6. The magnetic chuck according to claim 5, wherein a scale visible from outside is indicated on the locking plate.

7. The magnetic chuck according to claim 1, wherein the holding force adjustment member includes: a support body fixed to the cylinder tube; a locking shaft supported by the support body; and a locking ring having an annular shape and being fixed to the adjustment ring, and wherein a plurality of groove portions into which an engaging portion of the locking shaft is fitted, are formed at equal angular intervals in an inner circumference of the locking ring.

8. The magnetic chuck according to claim 7, wherein the holding force adjustment member includes a release knob fixed to the locking shaft, and the release knob is inserted into an elongate hole of the support body.

9. The magnetic chuck according to claim 8, wherein the holding force adjustment member includes a biasing spring disposed between the locking shaft and the support body, and the locking shaft abuts against the adjustment ring by a biasing force of the biasing spring.

10. The magnetic chuck according to claim 1, wherein an opening of the cylinder tube farther from the workpiece holding surface is closed by a top cover, an opening of the cylinder tube closer to the workpiece holding surface is closed by a bottom cover, an internal space of the cylinder tube is partitioned by the piston assembly into a first pressure chamber adjacent to the top cover and a second pressure chamber adjacent to the bottom cover, the base member includes a first air supply and discharge hole and a second air supply and discharge hole, the first pressure chamber communicates with the first air supply and discharge hole through a hole portion of the top cover, and the cylinder tube includes an air passage configured to place the second pressure chamber and the second air supply and discharge hole in communication with each other.

11. The magnetic chuck according to claim 10, wherein the cylinder tube includes an air passage configured to place the second pressure chamber and the first pressure chamber in communication with each other, and a flow rate regulating valve is disposed in the air passage.

12. The magnetic chuck according to claim 10, wherein an air discharge port is disposed in the base member, and a cooling air from the air discharge port is discharged to outside from a ventilation hole of the adjustment ring through at least a clearance between the adjustment body and the adjustment ring.

13. The magnetic chuck according to claim 12, wherein a cover body is attached to the base member, and the cooling air passes through a clearance between the cover body and the base member, a clearance between the cover body and the cylinder tube, and a clearance between the adjustment body and the cylinder tube, and thereafter passes through the clearance between the adjustment body and the adjustment ring.

14. The magnetic chuck according to claim 10, wherein an air discharge port is disposed in the base member, a cover body is attached to the base member, and an air discharged from the air discharge port is discharged to outside through a ventilation hole formed in the cover body.

15. The magnetic chuck according to claim 14, wherein a variable throttle valve is attached to the air discharge port, and a through hole is formed in the cover body, a flow passage area of the variable throttle valve being changed from an exterior of the cover body through the through hole.
